(19) United States
(12) Patent Application Publication
(10) Pub. No.: US 2026/0279377 A1
(43) Pub. Date: Sep. 17, 2026

(54) SEPARATION METHOD AND APPARATUS FOR SEPARATING FAR-FIELD AND NEAR-FIELD VOICE AND WEARABLE DEVICE

(71) Applicant: AAC Acoustic Technologies (Shanghai) Co., Ltd., Shanghai (CN)

(72) Inventors: Lianwu Chen, Shanghai (CN); Xuejing Sun, L.A., CA (US)

(21) Appl. No.: 19/339,370

(22) Filed: Sep. 25, 2025

Related U.S. Application Data
(63) Continuation of application No. PCT/CN2025/082501, filed on Mar. 14, 2025.

(51) Int. Cl. G10L 21/0308; G10L 25/30; H04R 1/40

(52) U.S. Cl. CPC G10L 21/0308; G10L 25/30; H04R 1/406; H04R 2430/25; H04R 2460/13

(57) ABSTRACT

The present application provides a far-field and near-field voice separation method and apparatus and a wearable device. The method includes: obtaining a near-field beamforming signal and a far-field beamforming signal according to microphone array signal obtained by first microphones in a target scenario and a beamforming algorithm; calculating a near-field voice masking matrix and a far-field voice masking matrix according to the near-field beamforming signal, the far-field beamforming signal and a bone conduction microphone signal; outputting a near-field voice according to the near-field beamforming signal and the near-field voice masking matrix; and outputting a far-field voice according to the far-field beamforming signal and the far-field voice masking matrix. In the present application, the near-field voice and the far-field voice can be effectively separated by fusing the bone conduction microphone signal and the traditional microphone array signal, so that the wearer voice and the far-field voice are obtained.

### TECHNICAL FIELD

The present application relates to the technical field of voice processing and, in particular, to a separation method and apparatus for separating a far-field and near-field voice and a wearable device.

### BACKGROUND

With the gradual popularity of wearable devices, such as a true wireless stereo (TWS) and augmented reality (AR) glasses, voice applications based on the wearable devices are also more and more extensive; in application scenarios, such as voice calls, voice assistants, and far-field translation, technologies for distinguishing between a speech of a wearer and a speech of another person are essential.

In terms of the voice call, the wearable device needs to be able to cancel sounds of a background speaker other than the wearer to provide a clear call experience; for the voice assistant function, the wearable device needs to be able to recognize a voice instruction of the wearer and provide a response; for the far-field translation scenario, the wearable device needs to be able to distinguish between sounds of the wearer and sounds of a far-field speaker, and thus be able to translate only the far-field voice.

A common solution in the prior art is to use a directional beamforming technology to pick up the far-field voice or near-field voice and input it to a relevant application based on multi-microphone audio signals picked up by a microphone array. However, although this solution can improve the signal-to-noise ratio of the near-field or far-field voice to some extent, it still cannot completely separate the near-field voice from the far-field voice.

Therefore, it is necessary to provide a far-field and near-field voice separation method and apparatus and a wearable device.

### SUMMARY

An objective of embodiments of the present application is to provide a far-field and near-field voice separation method and apparatus and a wearable device.

The technical solution of the present application is as follows.

In a first aspect, an embodiment of the present application provides a far-field and near-field voice separation method, including:
obtaining a near-field beamforming signal and a far-field beamforming signal according to microphone array signals obtained by first microphones in a target scenario and a beamforming algorithm;
calculating a near-field voice masking matrix and a far-field voice masking matrix according to the near-field beamforming signal, the far-field beamforming signal and a bone conduction microphone signal;
outputting a near-field voice according to the near-field beamforming signal and the near-field voice masking matrix; and
outputting a far-field voice according to the far-field beamforming signal and the far-field voice masking matrix.

As an improvement, the bone conduction microphone signal is obtained by:
obtaining a wearer voice signal obtained by a second microphone in the target scenario; and
using the wearer voice signal as the bone conduction microphone signal.

As an improvement, the calculating a near-field voice masking matrix and a far-field voice masking matrix according to the near-field beamforming signal, the far-field beamforming signal and a bone conduction microphone signal includes:
inputting the near-field beamforming signal, the far-field beamforming signal and the bone conduction microphone signal into a separation neural network to obtain the near-field voice masking matrix and the far-field voice masking matrix.

As an improvement, the separation neural network is a convolutional recurrent neural network, the convolutional recurrent neural network includes a convolutional neural network, a recurrent neural network and a deep neural network, and the inputting the near-field beamforming signal, the far-field beamforming signal and the bone conduction microphone signal into a separation neural network to obtain the near-field voice masking matrix and the far-field voice masking matrix includes:
inputting the near-field beamforming signal, the far-field beamforming signal and the bone conduction microphone signal into the convolutional neural network, and extracting a near-field audio feature and a far-field audio feature;
inputting the near-field audio feature and the far-field audio feature into the recurrent neural network, and extracting near-field voice information and far-field voice information; and
inputting the near-field voice information and the far-field voice information into the deep neural network to obtain the near-field voice masking matrix and the far-field voice masking matrix.

As an improvement, before the inputting the near-field beamforming signal, the far-field beamforming signal and the bone conduction microphone signal into the convolutional neural network, and extracting a near-field audio feature and a far-field audio feature, the method includes:
if an effective bandwidth of the bone conduction microphone signal is within a preset frequency range, increasing a number of convolutional kernels of the convolutional neural network and/or reducing a stride of the convolutional neural network; and
if the effective bandwidth of the bone conduction microphone signal is outside the preset frequency range, decreasing the number of the convolutional kernels of the convolutional neural network and/or increasing the stride of the convolutional neural network.

As an improvement, for the obtaining a near-field beamforming signal and a far-field beamforming signal according to microphone array signals obtained by first microphones in a target scenario and a beamforming algorithm, calculation formulas are as follows:

$${N}_{t , f} = {\sum }_{i = 1}^{5} {w}_{i , f}^{near} * {S}_{i , t , f} ;$$

$${F}_{t , f} = {\sum }_{i = 1}^{5} {w}_{i , f}^{far} * {S}_{i , t , f} ;$$

in which N_{t,f} represents the near-field beamforming signal, F_{t,f} represents the far-field beamforming signal, S_{i,t,f} represents a frequency domain signal of a fth frequency point of a tth voice frame after short-time Fourier transform (STFT) of a time domain signal Sᵢ of the ith microphone array signal,

$${w}_{i , f}^{near}$$

represents a first inter weight,

$${w}_{i , f}^{far}$$

represents a second filter weight, and i, t and f are positive integers.

As an improvement, for the outputting a near-field voice according to the near-field beamforming signal and the near-field voice masking matrix, a calculation formula is as follows:

$${N}_{t , f}^{′} = {N}_{t , f} * {M}_{t , f}^{near} ;$$

in which N′_{t,f} represents the near-field voice, N_{t,f} represents the near-field beamforming signal,

$${M}_{t , f}^{near}$$

represents the near-field voice masking matrix, and t and f are positive integers.

As an improvement, for the outputting a far-field voice according to the far-field beamforming signal and the far-field voice masking matrix, a calculation formula is as follows:

$${F}_{t , f}^{′} = {F}_{t , f} * {M}_{t , f}^{far} ;$$

in which F′_{t,f} represents the far-field voice, F_{t,f} represents the far-field beamforming signal,

$${M}_{t , f}^{far}$$

represents the tar-field voice masking matrix, and t and f are positive integers.

In a second aspect, an embodiment of the present application provides a far-field and near-field voice separation apparatus, including:
an acquisition module configured to obtain a near-field beamforming signal and a far-field beamforming signal according to microphone array signals obtained by first microphones in a target scenario and a beamforming algorithm;
a calculating module configured to calculate a near-field voice masking matrix and a far-field voice masking matrix according to the near-field beamforming signal, the far-field beamforming signal and a bone conduction microphone signal;
a first output module configured to output a near-field voice according to the near-field beamforming signal and the near-field voice masking matrix; and
a second output module configured to output a far-field voice according to the far-field beamforming signal and the far-field voice masking matrix.

In a third aspect, an embodiment of the present application provides a wearable device, including the far-field and near-field voice separation apparatus provided in the second aspect.

The present application has the following beneficial effects: the microphone array signals obtained by the first microphones in the target scenario are obtained, and the near-field beamforming signal and the far-field beamforming signal are obtained by using the beamforming algorithm; based on the near-field beamforming signal and the far-field beamforming signal, the near-field voice masking matrix and the far-field voice masking matrix are calculated on the basis of the bone conduction microphone signal, and the near-field voice and the far-field voice can be effectively separated by fusing the bone conduction microphone signal and the traditional microphone array signals, so that the wearer voice and the far-field voice are obtained.

### BRIEF DESCRIPTION OF DRAWINGS

FIG. 1 is a schematic diagram of an application scenario of a far-field and near-field voice separation method according to an embodiment of the present application;

FIG. 2 is a flow block diagram of a far-field and near-field voice separation method according to an embodiment of the present application;

FIG. 3 is a flow chart of a far-field and near-field voice separation method according to an embodiment of the present application;

FIG. 4 is a schematic structural diagram of a far-field and near-field voice separation apparatus according to an embodiment of the present application; and

FIG. 5 is a schematic structural diagram of a wearable device according to an embodiment of the present application.

### DESCRIPTION OF EMBODIMENTS

The present application is further described below with reference to the drawings and the embodiments.

FIG. 1 is a schematic diagram of an application scenario of a far-field and near-field voice separation method according to an embodiment of the present application, and as shown in FIG. 1, the method may be applied to wearable devices, such as a TWS and AR glasses, the description is given with the AR glasses as an example, and generally, the AR glasses include a plurality of first microphones, and a wearer wears the AR glasses. After receiving a separation instruction, a controller in the AR glasses obtains a near-field beamforming signal and a far-field beamforming signal according to microphone array signals obtained by first microphones in a target scenario and a beamforming algorithm; calculates a near-field voice masking matrix and a far-field voice masking matrix according to the near-field beamforming signal, the far-field beamforming signal and a bone conduction microphone signal; outputs a near-field voice according to the near-field beamforming signal and the near-field voice masking matrix; and outputs a far-field voice according to the far-field beamforming signal and the far-field voice masking matrix. Thus, the AR glasses can well separate the near-field voice and the far-field voice to eliminate the far-field voice outside the wearer, provides the wearer with a clear call experience, and improves the use experience of the wearer for the AR glasses.

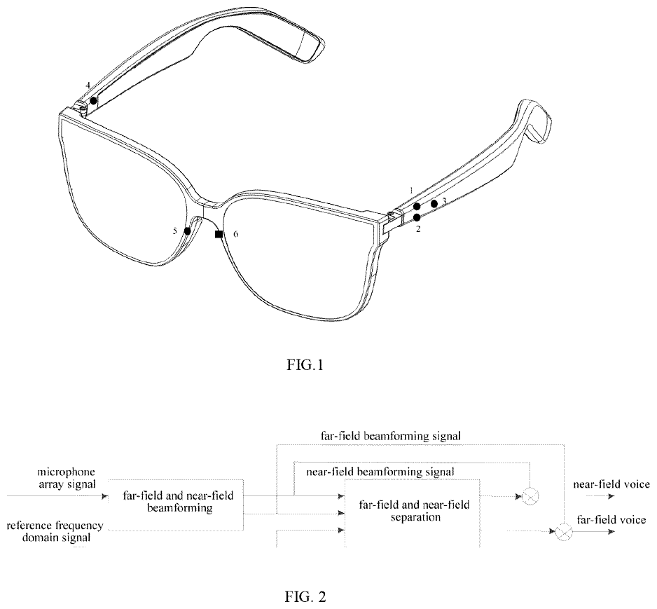

FIG. 2 is a flow block diagram of a far-field and near-field voice separation method according to an embodiment of the present application, and as shown in FIG. 2, microphone array signals obtained by first microphones are subjected to a far-field and near-field beamforming algorithm to obtain a near-field beam signal and a far-field beam signal; the near-field beam signal, the far-field beam signal and a bone conduction microphone signal are subjected to a far-field and near-field separation algorithm to obtain masking matrices corresponding to a far-field voice and a near-field voice; the near-field beam signal and the far-field beam signal are fused with the corresponding masking matrices, and the far-field beam signal and the near-field beam signal are multiplied by the corresponding masking matrices to obtain the near-field voice and the far-field voice which are separated.

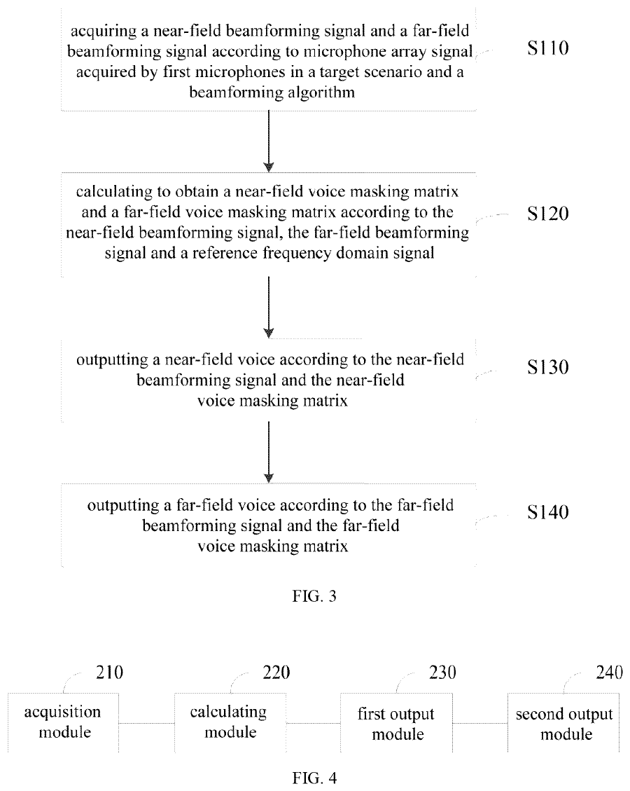

FIG. 3 is a flow chart of a far-field and near-field voice separation method according to an embodiment of the present application, and as shown in FIG. 3, the method includes the following steps.

The far-field and near-field voice separation method according to the embodiment of the present application is explained with an application to AR glasses as an example, the AR glasses include 5 first microphones, the first microphones are all traditional microphones, four of the first microphones are respectively located on two temples of the AR glasses, and the five microphones are indicated by the reference numerals 1 to 5 in FIG. 1; the other first microphone is located on a nose pad of the AR glasses; the AR glasses further include a second microphone, and the second microphone is also located on the nose pad of the AR glasses, and indicated by the reference numeral 6 in FIG. 1. The layout can well utilize the space on the glasses, and small and large microphone distances exist at the same time, so that more flexibility is provided for a beamforming algorithm.

A target scenario can be a scenario that a wearer wearing the AR glasses talks with another person, and in this target scenario, a sound of the wearer is a near-field voice, a sound of the other person is a far-field voice, and by performing this far-field and near-field voice separation method, the sounds of the wearer and the other person can be effectively separated to improve the use experience of the wear for the AR glasses.

S110: obtaining a near-field beamforming signal and a far-field beamforming signal according to microphone array signals obtained by first microphones in a target scenario and a beamforming algorithm.

The microphone array signals obtained by the first microphones in the target scenario are obtained, and the microphone array signals include audio signals obtained by the five first microphones and containing speaking audios of the wearer and speaking audios of the other people nearby. After the microphone array signals are obtained, the near-field beamforming signal and the far-field beamforming signal can be obtained through the beamforming algorithm.

The beamforming algorithm is a signal processing technology, and the beamforming algorithm has a core concept that weighted summation is performed on the microphone array signals received by the first microphones in the AR glasses, so as to form a beam with a specific directivity, which can enhance the signal strength in a desired direction while suppressing interference signals in other directions.

Exemplarily, when the near-field beamforming signal and the far-field beamforming signal are obtained with the beamforming algorithm, firstly, a signal model is required to be established to distinguish a near field from a far field; then, guide vectors are constructed to obtain a near-field guide vector and a far-field guide vector; and based on the near-field guide vector and the far-field guide vector, covariance matrix estimation is performed, and finally, separation is performed based on a minimum variance distortionless response algorithm or a subspace method, thereby obtaining the near-field beamforming signal and the far-field beamforming signal.

S120: calculating a near-field voice masking matrix and a far-field voice masking matrix according to the near-field beamforming signal, the far-field beamforming signal and a bone conduction microphone signal.

After the near-field beamforming signal and the far-field beamforming signal are obtained in the above step, in conjunction with the bone conduction microphone signal, the near-field voice masking matrix is calculated according to a relationship between the near-field beamforming signal and the bone conduction microphone signal; and the far-field voice masking matrix is calculated according to a relationship between the far-field beamforming signal and the bone conduction microphone signal.

In near-field voice processing, the near-field voice refers to a voice signal of the speaker close to the microphone (usually within several tens of centimeters). Due to a relatively complex near-field environment, various kinds of background noise and interference signals may be present; the near-field voice masking matrix is used to describe correlations between the voice signal and these interfering signals, and particularly plays a key role in the process of separating or enhancing the voice signal.

In a far-field voice environment, a voice signal source is relatively far from a microphone array. In this case, a signal propagation process is disturbed by more environmental factors, such as reverberation and long-distance background noise. The far-field voice masking matrix is mainly used to process such a complex far-field voice condition, and aims to highlight the target voice signal and suppress the interference signals.

S130: outputting a near-field voice according to the near-field beamforming signal and the near-field voice masking matrix.

S140: outputting a far-field voice according to the far-field beamforming signal and the far-field voice masking matrix.

After the near-field voice masking matrix is calculated according to the above method, the near-field beamforming signal is further refined and denoised according to the near-field beamforming signal and the near-field voice masking matrix to obtain the near-field voice; and the far-field beamforming signal is further refined and denoised according to the far-field beamforming signal and the far-field voice masking matrix to obtain the far-field voice.

Exemplarily, the near-field beamforming signal is multiplied by the near-field voice masking matrix to obtain the near-field voice; and the far-field beamforming signal is multiplied by the far-field voice masking matrix to obtain the far-field voice.

The embodiment of the present application provides the far-field and near-field voice separation method, the microphone array signals obtained by the first microphones in the target scenario are first obtained, and the near-field beamforming signal and the far-field beamforming signal are obtained by using the beamforming algorithm; based on the near-field beamforming signal and the far-field beamforming signal, the near-field voice masking matrix and the far-field voice masking matrix are calculated on the basis of the bone conduction microphone signal, and the near-field voice and the far-field voice can be effectively separated by fusing the bone conduction microphone signal and the traditional microphone array signals, so that the wearer voice and the far-field voice are obtained.

As an embodiment, the bone conduction microphone signal is obtained by:
obtaining a wearer voice signal obtained by a second microphone in the target scenario; and
using the wearer voice signal as the bone conduction microphone signal.

In the embodiment of the present application, the wearer voice signal in the target scenario is collected through the second microphone on the AR glasses, and generally, the second microphone can be located on the nose pad of the AR glasses to collect a speaking voice of the wearer at a short distance.

In practical implementation, after the wearer voice signal is collected, the wearer voice signal is usually transformed into a frequency domain, and the wearer voice signal transformed into the frequency domain is used as the bone conduction microphone signal.

The second microphone can be a voice accelerometer (VACC) or a voice pickup sensor (VPU), and the voice accelerometer and the voice pickup sensor can capture voice signals of the wearer through bones, muscles and other tissues, so that external environmental noise and interference voices are effectively isolated, thereby improving voice pickup accuracy and definition.

In some embodiments, the calculating a near-field voice masking matrix and a far-field voice masking matrix according to the near-field beamforming signal, the far-field beamforming signal and a bone conduction microphone signal includes:
inputting the near-field beamforming signal, the far-field beamforming signal and the bone conduction microphone signal into a separation neural network to obtain the near-field voice masking matrix and the far-field voice masking matrix.

In the embodiment of the present application, the near-field beamforming signal, the far-field beamforming signal and the bone conduction microphone signal are input into the separation neural network, and the separation neural network can output the near-field voice masking matrix and the far-field voice masking matrix.

As an embodiment, the separation neural network is a convolutional recurrent neural network, the convolutional recurrent neural network includes a convolutional neural network, a recurrent neural network and a deep neural network, and the inputting the near-field beamforming signal, the far-field beamforming signal and the bone conduction microphone signal into a separation neural network to obtain the near-field voice masking matrix and the far-field voice masking matrix includes:
inputting the near-field beamforming signal, the far-field beamforming signal and the bone conduction microphone signal into the convolutional neural network, and extracting a near-field audio feature and a far-field audio feature;
inputting the near-field audio feature and the far-field audio feature into the recurrent neural network, and extracting near-field voice information and far-field voice information; and
inputting the near-field voice information and the far-field voice information into the deep neural network to obtain the near-field voice masking matrix and the far-field voice masking matrix.

In the embodiment of the present application, the separation neural network is a convolutional recurrent neural network, the convolutional recurrent neural network is composed of the convolutional neural network (CNN), the recurrent neural network (RNN) and the deep neural network (DNN), and steps for obtaining the near-field voice masking matrix and the far-field voice masking matrix are specifically as follows:
first, combining the near-field beamforming signal, the far-field beamforming signal and the bone conduction microphone signal into an input feature, wherein the input feature may be represented by Fea∈C^{T×F×C}, wherein T represents a number of signal frames, F represents a number of frequency bands of the signal, C represents a number of input channels, and C is 3 in the embodiment of the present application, which indicates that the wearable device includes three channels, namely a near-field channel, a far-field channel and a bone conduction channel; and
inputting the input feature into the convolutional neural network, and extracting the near-field audio feature and the far-field audio feature through the convolutional neural network; then inputting the near-field audio feature and the far-field audio feature into the recurrent neural network, and modeling a time sequence of the voice signal through the recurrent neural network, so as to extract the near-field voice information and the far-field voice information; and finally, inputting the near-field voice information and the far-field voice information into the deep neural network to obtain the near-field voice masking matrix and the far-field voice masking matrix.

As an embodiment, before the inputting the near-field beamforming signal, the far-field beamforming signal and the bone conduction microphone signal into the convolutional neural network, and extracting a near-field audio feature and a far-field audio feature, the method includes:
if an effective bandwidth of the bone conduction microphone signal is within a preset frequency range, increasing a number of convolutional kernels of the convolutional neural network and/or reducing a stride of the convolutional neural network; and
if the effective bandwidth of the bone conduction microphone signal is outside the preset frequency range, decreasing the number of the convolutional kernels of the convolutional neural network and/or increasing the stride of the convolutional neural network.

In the embodiment of the present application, before the bone conduction microphone signal is input into the convolutional neural network, the effective bandwidth of the bone conduction microphone signal is compared with the preset frequency range, and if the effective bandwidth of the bone conduction microphone signal is within the preset frequency range, the number of the convolutional kernels of the convolutional neural network is increased, and/or the stride of the convolutional neural network is reduced; if the effective bandwidth of the bone conduction microphone signal is outside the preset frequency range, the number of the convolutional kernels of the convolutional neural network is reduced, and/or the stride of the convolutional neural network is increased.

For example, the preset frequency range is 0 to 2 KHz. By combining the frequency response characteristics of the VACC/VPU signals, different network structures can be adopted for different frequency bands, the VACC/VPU signals are effectively utilized, and meanwhile, overall complexity is reduced. For example, the effective bandwidth of the VACC is only about 2 KHz, for frequency bands below 2 KHz, the convolutional neural network can adopt more convolutional kernels and a smaller stride, and the VACC is better utilized to separate the far and near-field voices through refined modeling; for frequency bands above 2 KHz, fewer convolutional kernels and a larger stride can be employed, thereby reducing the overall complexity of the convolutional neural network.

As an example, for the obtaining a near-field beamforming signal and a far-field beamforming signal according to microphone array signals obtained by first microphones in a target scenario and a beamforming algorithm, calculation formulas are as follows:

$${N}_{t , f} = {\sum }_{i = 1}^{5} {w}_{i , f}^{near} * {S}_{i , t , f} ;$$

$${F}_{t , f} = {\sum }_{i = 1}^{5} {w}_{i , f}^{far} * {S}_{i , t , f} ;$$

wherein N_{t,f} represents the near-field beamforming signal, F_{t,f} represents the far-field beamforming signal, S_{i,t,f} represents a frequency domain signal of a f-th frequency point of a t-th voice frame after STFT transformation of a time domain signal Sᵢ of the i-th microphone array signal,

$${w}_{i , f}^{near}$$

represents a second filter weight,

$${w}_{i , f}^{far}$$

represents a first niter weight, and i, t and f are positive integers.

It should be noted that the first filter weight and the second filter weight are determined according to specific layout information of the microphones.

As an example, for the outputting a near-field voice according to the near-field beamforming signal and the near-field voice masking matrix, a calculation formula is as follows:

$${N}_{t , f}^{′} = {N}_{t , f} * {M}_{t , f}^{near} ;$$

wherein N′_{t,f} represents the near-field voice, N_{t,f} represents the near-field beamforming signal,

$${M}_{t , f}^{near}$$

represents the near-field voice masking matrix, and t and f are positive integers.

As an example, for the outputting a far-field voice according to the far-field voice masking matrix and the far-field beamforming signal, a calculation formula is as follows:

$${F}_{t , f}^{′} = {F}_{t , f} * {M}_{t , f}^{far} ;$$

wherein F′_{t,f} represents the far-field voice, F_{t,f} represents the far-field beamforming signal,

$${M}_{t , f}^{far}$$

represents the far-field voice masking matrix, and t and f are positive integers.

FIG. 4 is a schematic structural diagram of a far-field and near-field voice separation apparatus according to an embodiment of the present application, and as shown in FIG. 4, the apparatus includes:
an acquisition module 210 configured to obtain a near-field beamforming signal and a far-field beamforming signal according to microphone array signals obtained by first microphones in a target scenario and a beamforming algorithm;
a calculating module 220 configured to calculate a near-field voice masking matrix and a far-field voice masking matrix according to the near-field beamforming signal, the far-field beamforming signal and a bone conduction microphone signal;
a first output module 230 configured to output a near-field voice according to the near-field beamforming signal and the near-field voice masking matrix; and
a second output module 240 configured to output a far-field voice according to the far-field beamforming signal and the far-field voice masking matrix.

The present embodiment is an apparatus embodiment corresponding to the above method, the implementation process thereof is the same as that of the method embodiment, and reference may be made to the above method embodiment for details which are not repeated herein.

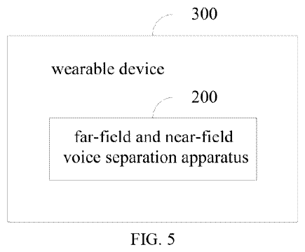

FIG. 5 is a schematic structural diagram of a wearable device according to an embodiment of the present application, and as shown in FIG. 5, the wearable device 300 includes the above far-field and near-field voice separation apparatus 200. The wearable device includes a TWS, AR glasses, or the like.

The above description is only embodiments of the present application, and it should be noted that improvements can be made by those of ordinary skill in the art without departing from the concept of the present application, and all fall within the protection scope of the present application.

What is claimed is:

1. A method for separating a far-field and near-field voice, comprising:
obtaining a near-field beamforming signal and a far-field beamforming signal according to a microphone array signal obtained by a first microphone in a target scenario and based on a beamforming algorithm;
calculating to obtain a near-field voice masking matrix and a far-field voice masking matrix according to the near-field beamforming signal, the far-field beamforming signal and a bone conduction microphone signal;
outputting a near-field voice according to the near-field beamforming signal and the near-field voice masking matrix; and
outputting a far-field voice according to the far-field beamforming signal and the far-field voice masking matrix.

2. The method as described in claim 1, wherein the bone conduction microphone signal is obtained by:
obtaining a wearer voice signal obtained by a second microphone in the target scenario; and
taking the wearer voice signal as the bone conduction microphone signal.

3. The method as described in claim 1, wherein the calculating to obtain the near-field voice masking matrix and the far-field voice masking matrix according to the near-field beamforming signal, the far-field beamforming signal and the bone conduction microphone signal comprises:
inputting the near-field beamforming signal, the far-field beamforming signal and the bone conduction microphone signal into a separation neural network to obtain the near-field voice masking matrix and the far-field voice masking matrix.

4. The method as described in claim 3,
wherein the separation neural network is a convolutional recurrent neural network, the convolutional recurrent neural network comprises a convolutional neural network, a recurrent neural network and a deep neural network,
wherein the inputting the near-field beamforming signal, the far-field beamforming signal and the bone conduction microphone signal into the separation neural network to obtain the near-field voice masking matrix and the far-field voice masking matrix comprises:
inputting the near-field beamforming signal, the far-field beamforming signal and the bone conduction microphone signal into the convolutional neural network, and extracting a near-field audio feature and a far-field audio feature;
inputting the near-field audio feature and the far-field audio feature into the recurrent neural network, and extracting near-field voice information and far-field voice information; and
inputting the near-field voice information and the far-field voice information into the deep neural network to obtain the near-field voice masking matrix and the far-field voice masking matrix.

5. The method as described in claim 4, wherein before the inputting the near-field beamforming signal, the far-field beamforming signal and the bone conduction microphone signal into the convolutional neural network, and extracting the near-field audio feature and the far-field audio feature, the method comprises:
increasing a number of convolutional kernels of the convolutional neural network and/or reducing a stride of the convolutional neural network in response to an effective bandwidth of the bone conduction microphone signal being within a preset frequency range; and
decreasing the number of the convolutional kernels of the convolutional neural network and/or increasing the stride of the convolutional neural network in response to the effective bandwidth of the bone conduction microphone signal being outside the preset frequency range.

6. The method as described in claim 1, wherein for the obtaining the near-field beamforming signal and the far-field beamforming signal according to the microphone array signal obtained by the first microphone in the target scenario and the beamforming algorithm, calculation formulas are as follows:
$${N}_{t , f} = {\sum }_{i = 1}^{5} {w}_{i , f}^{near} * {S}_{i , t , f} ;$$
$${F}_{t , f} = {\sum }_{i = 1}^{5} {w}_{i , f}^{far} * {S}_{i , t , f} ;$$
wherein N_{t,f} represents the near-field beamforming signal, F_{t,f} represents the far-field beamforming signal, S_{i,t,f} represents a frequency domain signal of a f-th frequency point of a t-th voice frame after short-time Fourier transform (STFT) of a time domain signal Sᵢ of the i-th microphone array signal,
$${w}_{i , f}^{near}$$
represents a first filter weight,
$${w}_{i , f}^{far}$$
represents a second filter weight, where i, t and f are positive integers.

7. The method as described in claim 1, wherein for the outputting the near-field voice according to the near-field beamforming signal and the near-field voice masking matrix, a calculation formula is as follows:
$${N}_{t , f}^{′} = {N}_{t , f} * {M}_{t , f}^{near} ;$$
wherein N′_{t,f} represents the near-field voice, N_{t,f} represents the near-field beamforming signal,
$${M}_{t , f}^{near}$$
represents the near-field voice masking matrix, where t and f are positive integers.

8. The method as described in claim 1, wherein for the outputting the far-field voice according to the far-field beamforming signal and the far-field voice masking matrix, a calculation formula is as follows:
$${F}_{t , f}^{′} = {F}_{t , f} * {M}_{t , f}^{far} ;$$
wherein F′_{t,f} represents the far-field voice, F_{t,f} represents the far-field beamforming signal,
$${M}_{t , f}^{far}$$
represents the far-field voice masking matrix, where t and f are positive integers.

9. An apparatus for separating a far-field and near-field voice, comprising:
an acquisition module configured to obtain a near-field beamforming signal and a far-field beamforming signal according to microphone array signal obtained by a first microphone in a target scenario and a beamforming algorithm;
a calculating module configured to calculate and obtain a near-field voice masking matrix and a far-field voice masking matrix according to the near-field beamforming signal, the far-field beamforming signal and a bone conduction microphone signal;
a first output module configured to output a near-field voice according to the near-field beamforming signal and the near-field voice masking matrix; and
a second output module configured to output a far-field voice according to the far-field beamforming signal and the far-field voice masking matrix.

10. A wearable device, comprising the separation apparatus as described in claim 9.
